(19) United States
(12) Patent Application Publication
(10) Pub. No.: US 2020/0331009 A1
(43) Pub. Date: Oct. 22, 2020

(54) Mister

(71) Applicants: Gary Stephen Moore, Dallas, TX (US); James D. Wilson, Benton, AR (US)

(72) Inventors: Gary Stephen Moore, Dallas, TX (US); James D. Wilson, Benton, AR (US)

(21) Appl. No.: 16/920,620

(22) Filed: Jul. 3, 2020

Related U.S. Application Data
(63) Continuation of application No. 16/389,007, filed on Apr. 19, 2019, now abandoned.
(60) Provisional application No. 62/659,978, filed on Apr. 19, 2018.

(51) Int. Cl. B05B 3/10; B05B 3/12

(52) U.S. Cl. CPC B05B 3/1014; B05B 3/12; A01M 1/2044; B05B 3/1021; A01M 2200/012; B05B 3/1035

(57) ABSTRACT

Exemplary embodiments of a mister of the current invention comprise a reservoir, a spacer, and a dispenser assembly. A spacer fixedly joins the reservoir to the dispenser assembly a set distance. A liquid stored within the reservoir is configured to exit the reservoir at the valve through the spacer and impinge the dispenser assembly.

The dispenser assembly includes a dispenser and a motor, the motor providing a rotational force for application to the dispenser. The dispenser presents an axis oriented to the liquid stream flow from the reservoir. Upon liquid stream flow impinging the rotating dispenser, the centrifugal force causes the liquid stream flow to spread radially from the dispenser to the air and/or surface in the target area, where it is dispersed outwardly over a target area, atomized or as droplets.

### BACKGROUND

### Field of the Invention

The present invention relates to a system for dispensing liquids, more specifically to a mister.

### Description of the Related Art

It is often desirable to disperse liquid around an area. For example, it may be desirable to disperse a liquid mist for insect control or humidification.

### SUMMARY

Exemplary embodiments of a mister of the current invention comprise a reservoir, a spacer, and a dispenser assembly. A spacer fixedly joins the reservoir to the dispenser assembly a set distance. A liquid stored within the reservoir is configured to exit the reservoir at the valve through the spacer and impinge the dispenser assembly.

The dispenser assembly includes a dispenser and a motor, the motor providing a rotational force for application to the dispenser. The dispenser presents an axis oriented toward the liquid stream flow from the reservoir. Upon liquid stream flow impinging the rotating dispenser, the centrifugal force causes the liquid stream flow to spread radially from the dispenser to the air and/or surface in the target area, where it is dispersed outwardly over a target area, atomized or as droplets.

These and other features, aspects, and advantages of the invention will become better understood with reference to the following description, and accompanying drawings.

### BRIEF DESCRIPTION OF THE DRAWINGS

FIGS. 1A and 1B depict schematics for an embodiment of a mister according to the current invention;

FIG. 2 depicts a dispenser configuration for embodiments of misters according to the current invention;

FIGS. 3A-3C depict dispenser configurations for embodiments of misters according to the current invention;

FIGS. 4A-4C depict dispenser configurations for embodiments of misters according to the current invention;

FIGS. 5A-5C depict dispenser protrusion configurations for embodiments of misters according to the current invention; and

FIGS. 6A and 6B depict an embodiment of a mister according to the current invention as it may exist in operation.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

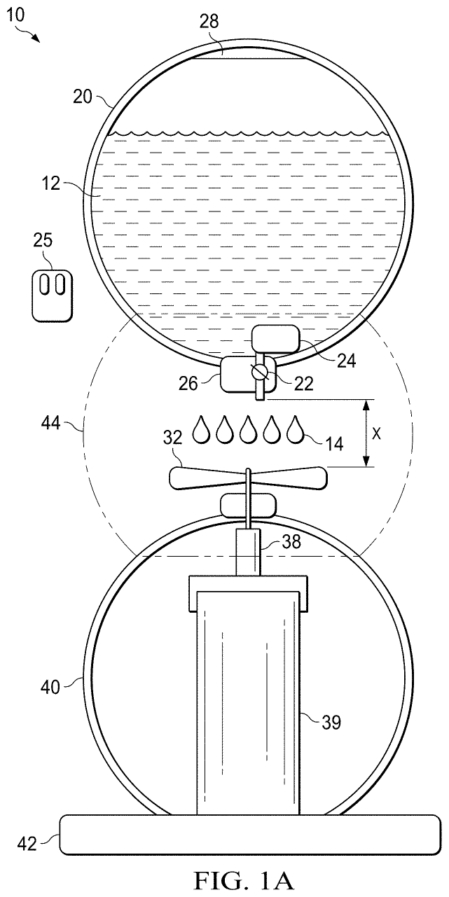

Exemplary embodiments of the present invention are directed to a mister 10, for dispersing liquids, such as an insect repellent. FIGS. 1A and 1B illustrate representative embodiments of a mister 10 according to the current invention. Depicted are a reservoir 20, a spacer 44, and a dispenser assembly 30. A liquid 12 exits the reservoir 20 through the spacer 44 and impinges the dispenser assembly 30 where it is dispersed outwardly over an area, atomized or as droplets.

The term “liquids” as used in this specification denotes liquid substance, which includes, for example, insect repellents, insecticides, pesticides, herbicides, and others. A suitable liquid has suitable viscosity and adhesion in order to exit the reservoir 20 and impinge the dispenser 32 and be dispersed outwardly.

The reservoir 20 is operable to hold liquid 12 for release to the dispenser assembly 30. The depicted reservoir 20 includes a wall 21, fill opening 28, valve 22, pump 26, and an outlet. The illustrated reservoir 20 is shaped and dimension to hold liquid 12 and allow a gravity feed to the dispenser assembly 30 via an opening located at the bottom of the reservoir 20.

The valve 22 is controllably actuated and controls exit flow of the liquid 12 from the reservoir 20 to the dispenser assembly 30 at the opening disposed at the bottom of the reservoir 20 to the dispenser assembly 30. A liquid pump 26 is located proximate the bottom of the reservoir 20 in fluid communication with the liquid valve 22, such that a liquid stream exits the reservoir 20 (illustrated as droplets 14). One or more switches, manual, electric, wireless, or other known in the art, can control actuation of the valve 22 or powering the liquid pump 26.

A spacer 44 is operable to maintain a target distance X between the reservoir 20 and the dispenser assembly 30, and is illustrated below the reservoir 20 and above the dispenser assembly 30. An exemplary spacer 44 fixedly joins the reservoir 20 and dispenser assembly 30. It also maintains at least a partial open field of view so that liquid 12 dispersed from the dispenser assembly 30 has an unimpeded exit path.

The mister 10 includes a dispenser assembly 30 operable to disperse the liquid 12 outwardly over the desired coverage region. The dispenser assembly 30 includes a dispenser 32 and a motor 38. Certain configurations include housing 40 bounding some or all of the dispenser assembly 30. Motor 38 provides a rotational force for application to the dispenser 32, generally transverse in certain configurations (shown as a rotating shaft on the Z axis) to the liquid stream 14. A switch controls power to the motor 38. The motor 38 can be configured to impart different rotational characteristics, such as speed, to the dispenser 32, thereby controlling the area over which the liquid 12 travels, particle 16 size, and other characteristics. For this purpose, the switch 24 can control different power levels (e.g. low, medium and high) and have associated indicia therewith. Illustrated are an electric DC motor 38 and a power supply 39. The power supply 39 can be battery, rechargeable or otherwise, and/or alternate power sources known in the art, such as a solar power source.

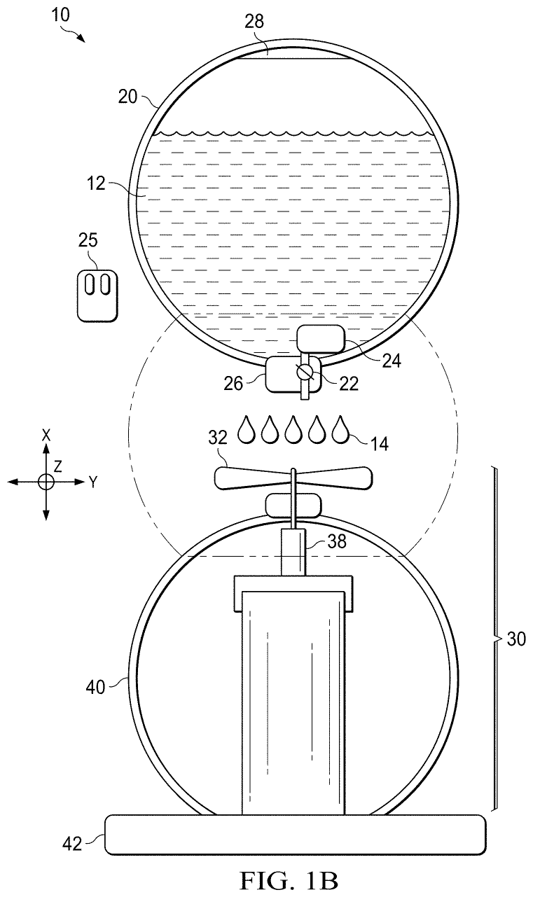

The motor 38 provides a rotational force for application to the dispenser 32 (illustrated in FIG. 1B as the directional arrow). Various embodiments employ various dispensers 32 46 48 50. FIGS. 2A-2C illustrate various dispensers 32. An exemplary dispenser 32 presents a contact surface 34 oriented to the liquid stream flow 14 from the reservoir 20. When the liquid stream flow 14 exits from the reservoir 20, it impinges the contact surface 34 of the rotating dispenser 32. The centrifugal force causes the liquid stream flow 14 to spread radially from the dispenser 32 to the air and/or surface in the desired coverage region. Various dispenser 32 configurations, such as dispenser 32 sizing, reservoir 20 to dispenser 32 spacing, liquid stream flow 14 to dispenser 32 angle, and other configurable options impact the liquid 14 dispersement characteristics, such as the distance from the mister 10, the degree of atomization, distribution of particle size, and other dispersement characteristics of the liquid stream 14. The dimensions, projection zone, and fluid distribution are optimized by dispenser 32 configuration.

FIG. 2 illustrates a dispenser 32 generally shaped as a propeller 46 having a configured length (X), width (Y), and pitch for target travel characteristics. The propeller 46 comprises rotating blades or vanes, presenting a contact surface 34 oriented to the liquid stream 14.

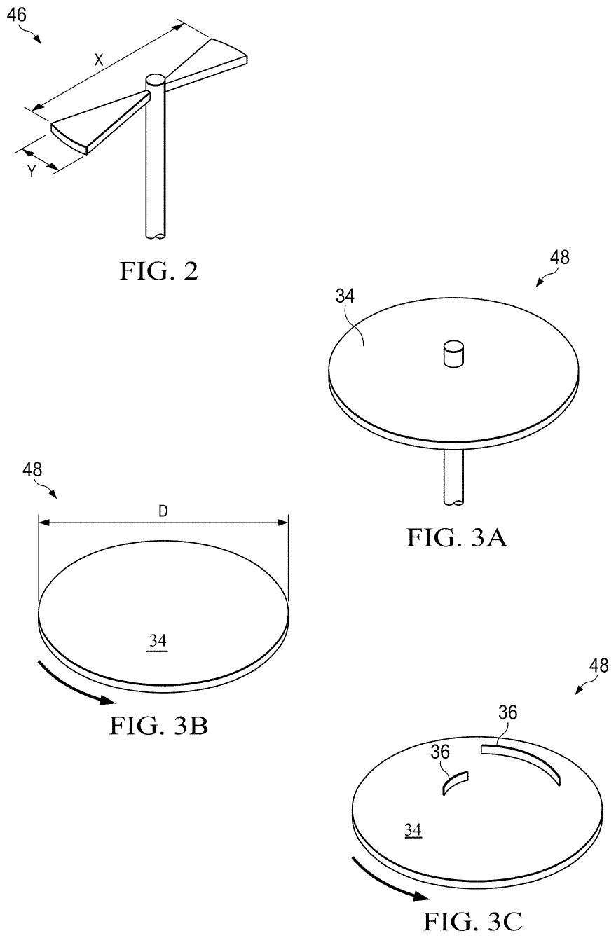

FIGS. 3A-3C illustrate dispensers 32 generally shaped as a disk 48, presenting a contact surface 34. The dispensers 32 present a generally planar contact surface 34 facing the liquid stream 14 and have a configured width (D) for target travel characteristics.

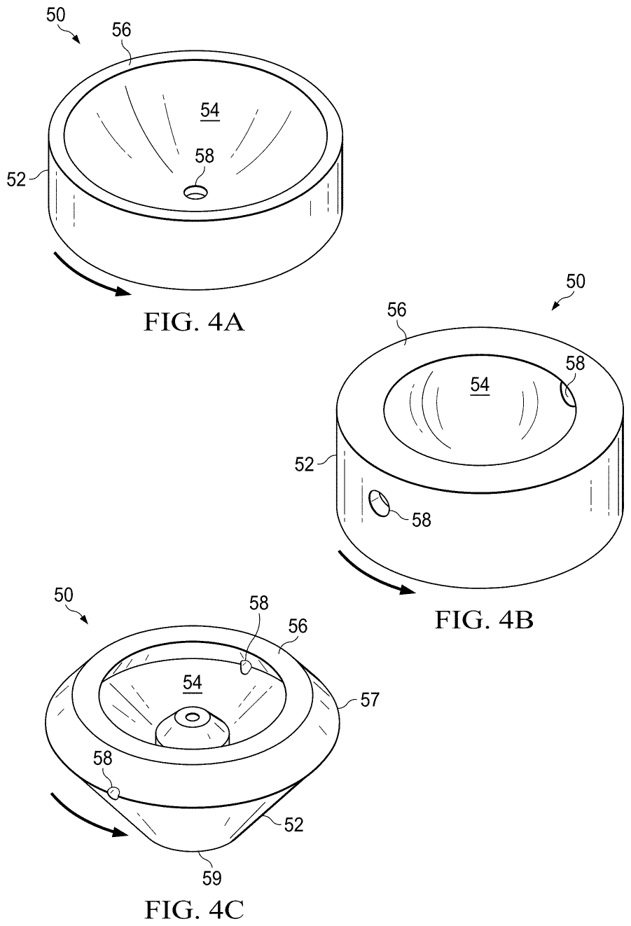

FIGS. 4A-4C illustrate dispenser 32 configurations generally shaped as a bowl 50. The bowls 50 include a sidewall 52 having an upper edge 56 and a cavity 54 presenting a contact surface 34 for receipt of a liquid. FIG. 4A illustrates such a configuration, where an exit mist 16 occurs at the upper edge 56. FIG. 4B illustrates a bowl configuration where the sidewall 52 includes one or more apertures 58. In certain configurations, two apertures 58 are disposed within the sidewall 52, in an opposing relationship. In certain configurations, the one or more apertures 58 are sized such that a significant portion of the exit mist 16 particle size distribution is about 100 micrometers. FIG. 4C illustrates a bowl configuration where the sidewall 52 expands outwardly from the base 59 to an apex 57 and recesses inwardly to its upper edge 56. This configuration includes one or more apertures 58 disposed within the sidewall 52, at or proximate the apex 57 in exemplary configuration.

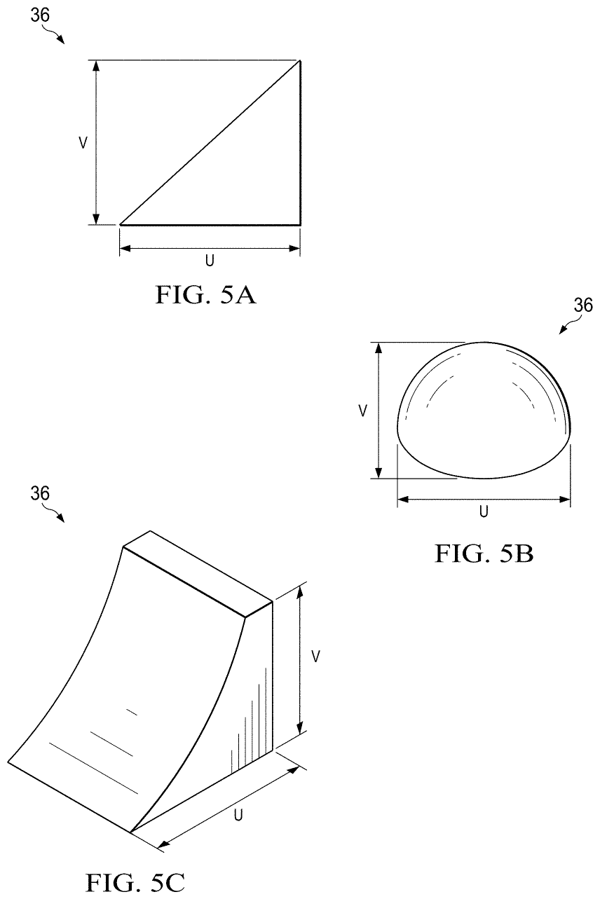

FIGS. 5A-5C illustrate projections 36 which are disposed on the contact surface 34 of dispensers 32 46 48 50 in certain configurations. The projections 36 rise from contact surface, altering exit mist 16 characteristics. The projections 36 can take different profiles and placement, with varying profiles and placement impacting the number, size, and density of small droplets, overall exit mist 16 flow, and the efficiency of the atomizer at varying speeds. The projections have a target width U and height V for target exit mist 16 characteristics. For example, the projections 36 may take a triangular profile (FIG. 5A), bump profile (FIG. 5B), ramped profile (FIG. 5C), semi-circular, curvilinear, or other profiles.

FIG. 3C illustrates a dispenser 32 generally shaped as a disk 48. Again, the dispenser 32 presents a contact surface 34 oriented toward the exit opening of the reservoir 20 for the liquid stream 14 and has a configured width (X) for target travel characteristics. For example, some target characteristics can include high atomization, large droplets for resting and/or evaporating from the target area of the surface, a mixture thereof, or other characteristics. The dispenser 32 of this configuration further include various projections 36 that alter the flight characteristics, such as trajectory and degree of atomization. The configuration can include projections 36 at points within the dispenser 32, edges of the dispenser 32, or span a partial or complete circumference of the dispenser 32. The configuration can include projections 36 that within the interior of the dispenser 32 or at the perimeter of the dispenser 32. The configuration can include one or more projections 36 spaced about the dispenser 32 concentrically, asymmetrically, or otherwise. Radially concentric placement of projections 36 can be employed for secondary or tertiary atomization effect.

As previously disclosed, the illustrated pump 26, valve 22, and dispenser 32 have switches, which actuate and empower the respective components. A representative power switch closes an electrical circuit thereby actuating the mister 10. In exemplary configuration, a single throw user engaged switch activates the mister 10. The switch may be manual, such as a button on the mister 10, or the switch may comprise remote switch elements such as wireless switch 25 or the like. In other configurations, a timer is included for activating the mister 10 for a period of time.

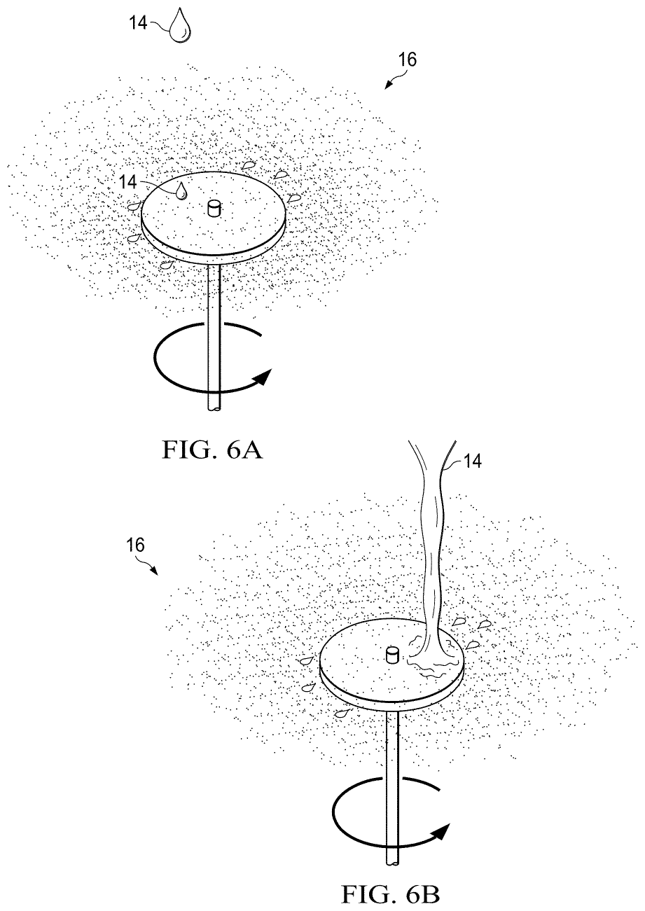

FIGS. 6A and 6B illustrate representative operation of a mister 10. A mister 10 can be placed on the ground or suspended. A liquid 12 such as a mosquito repellent is poured into the reservoir 20 at the fill opening 28. The liquid 12 is gravity fed or pump fed from the reservoir 20 via the valve 22 and released on into the rotating disk dispenser 32 48 of the dispenser assembly 30 which atomizes the droplets and disperses them over the target area, in order to dispense the repellent into the air and/or on surfaces where mosquitoes and flies might land.

A motor 38 provides a rotating shaft, which is connected to the dispenser 32, causing the dispenser 32 to rotate. The liquid 12 is oriented towards the dispenser 32 (FIG. 6A). Liquid 12 from the reservoir is directed through the valve 22 onto the dispenser. A liquid stream of droplets 14 are released and directed toward the dispenser 32 (FIG. 6B). During rotation of the dispenser 32, the impingement induces a radially outwardly directed flow by centrifugal forces to be thrown outward. The liquid stream 06 may contact projections 36 or the edge of the disk. This causes exit mist 16 to discharge. In addition, the radial airflow passes through mixing with the liquid droplets atomizing them.

Certain configurations of the mister 10 include a base and drip pan 42 to catch overflow and reuse the liquid. In certain configurations, the base is angled, altering mist output direction, by adjustment/pivoting of the base. The base may be pivoted such that the spacer's 44 open face (and in turn the mist output) would be dispensed in an alternate direction or spread.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. Apparatus for dispensing liquid insect repellent, said apparatus comprising:
a reservoir and a dispenser assembly;
said reservoir operable to contain said liquid insect repellent, said reservoir comprising, a wall, a fill opening, a valve, and an outlet whereby a liquid stream flows exits said reservoir;
said reservoir joined with said dispenser assembly a target distance;
said dispenser assembly comprises a dispenser and a motor, said motor providing a rotational force for application to said dispenser;
said dispenser presenting a contact surface oriented toward said outlet of said reservoir;
whereby said exit liquid stream impinges said rotating dispenser, it is dispersed as an exit mist outwardly over a target area.

2. The apparatus of claim 1, further comprising a pump in fluid communication with said reservoir, operable to direct said liquid insect repellent through said outlet.

3. The apparatus of claim 1, further comprising a power supply in communication with said motor.

4. The apparatus of claim 1, further comprising a wireless switch, operable to actuate said motor.

5. The apparatus of claim 1, wherein said dispenser is shaped as a propeller, the blades of said propeller defining the contact surface.

6. The apparatus of claim 1, wherein said dispenser is generally shaped as a disk, said disk surface defining said contact surface.

7. The apparatus of claim 1, wherein said dispenser is generally shaped as a bowl, said bowl comprising a base, a sidewall extending upwardly to an upper edge, and a cavity.

8. The apparatus of claim 7, wherein said sidewall includes at least one aperture for exit mist flow.

9. The apparatus of claim 8, wherein said sidewall includes two apertures.

10. The apparatus of claim 9, wherein said apertures are disposed in an opposing relationship.

11. The apparatus of claim 8, wherein said apertures are sized such that a major portion of said exit mist particle size distribution is 100 micrometers.

12. The apparatus of claim 7, wherein said sidewall expands outwardly from said base to an apex and recesses inwardly to said upper edge.

13. The apparatus of claim 12, wherein said sidewall includes at least one aperture for exit mist flow.

14. The apparatus of claim 13, wherein said aperture is disposed proximate said apex.

15. The apparatus of claim 13, wherein said sidewall includes two apertures.

16. The apparatus of claim 15, wherein said apertures are disposed in an opposing relationship.

17. The apparatus of claim 16, wherein said apertures are disposed proximate said apex.

18. The apparatus of claim 13, wherein said apertures are sized such that a major portion of said exit mist particle size distribution is 100 micrometers.

19. The apparatus of claim 1, wherein said contact surface includes projections rising from said contact surface.

20. The apparatus of claim 1, wherein said projections have one of following profiles: triangular, bump, and ramped.
